(19) United States
(12) Patent Application Publication
(10) Pub. No.: US 2010/0231687 A1
(43) Pub. Date: Sep. 16, 2010

(54) System and method for capturing, combining and displaying 360-degree "panoramic" or "spherical" digital pictures, images and/or videos, along with traditional directional digital images and videos of a site, including a site audit, or a location, building complex, room, object or event

(75) Inventors: David Amory, Charlotte, NC (US); William Amann, Charlotte, NC (US); John Yeagley, Waxhaw, NC (US); Michael Rockwell, Huntersville, NC (US); Doug Shuntich, Charlotte, NC (US)

Correspondence Address: DAVID AMORY, SUITE 213, 8001 RAINTREE LANE, CHARLOTTE, NC, 28277, US

(73) Assignee: Chase Real Estate Services Corporation

(21) Appl. No.: 12/661,227

(22) Filed: Mar. 12, 2010

Related U.S. Application Data
(60) Provisional application No. 61/210,028, filed on Mar. 16, 2009.

(51) Int. Cl. H04N 7/00

(52) U.S. Cl. 348/36; 348/E05.024

(57) ABSTRACT

One embodiment of a system and method for using a 360-degree panoramic camera or 360-degree panoramic video camera for capturing images of a site, location or object, including site audits, may include using such camera at various prescribed heights and locations in conjunction with a processing unit configured to display information and images of the subject site location or object. The processing unit may be configured with a software viewer to display images and information of interest and incorporating icons for purposes of selecting a corresponding point of view or information portal. A compressor unit may be used to receive photographic data from the camera system and interface with the processor. A storage unit may be configured to store captured and combined images of the site, location or object.

### CROSS-REFERENCE TO RELATED APPLICATIONS

This application claims the benefit of PPA Ser. No. 61/210,028, filed 2009 Mar. 16 by the present inventors, which is incorporated by reference.

### PRIOR ART

The following is a tabulation of some prior art that presently appears relevant:

U.S. Patent Application Publications

| Publication Nr. | Kind Code | Publ. Date | Applicant |
|---|---|---|---|
| 20090049094 | A1 | Feb. 19, 2009 | Howell; Clark David et al |
| 20090048949 | A1 | Feb. 19, 2009 | Howell; Clark David et al |

### BACKGROUND

The wireless telecommunications industry has experienced considerable growth over the past fifteen years with expanding markets, evolving technologies and burgeoning infrastructure (primarily regarding cell site facilities) development. Wireless carriers, tower companies, utilities and others with a vested interest in constructing, monitoring, maintaining and operating wireless infrastructure routinely perform site audits on such facilities. These site audits are an inspection and documentation of the physical characteristics and conditions of a cell site facility.

Traditionally, cell site audits and inspections have been performed for purposes of regulatory compliance, to verify that the various installations are built per construction drawings and whatever installation and application was initially proposed, and generally to document the status and condition of a particular cell site at a particular point in time. These audits and inspections typically involve a person conducting an on-site visit and documenting the condition or physical characteristics of the facility by way of notations on a check list accompanied by a photographic gallery of still pictures depicting antennas, antenna mounts and platforms, lines, ground equipment such as shelters or cabinets housing radios, the tower or antenna support structure, compound fencing, gate access and signage, and other germane aspects of the facility.

Although paper forms or reports with attached photographs have customarily been an accepted way of documenting a cell site's condition, the person reviewing the report has a limited sense of what the site actually looks like and is put in the passive role of reviewing essentially static material. In a related context, a system and method for performing site audits on facilities together with managing photographs from site audits (identifying and representing deficiencies in a restaurant or other facility) has been proposed—for example, in U.S. patent applications 20090048949 and 20090049094 (2009) by Howell, Clark David et al with Assignee being Facility Audit Solutions, LLC. However, the disadvantage still lies in the fact that the viewer or reviewer of such an audit does not have the advantage of being immersed visually within the subject matter of the audit. Site audit methods heretofore known suffer from a number of other disadvantages;
(a) What is captured by way of still image photography does not afford the viewer the opportunity to take a good look around with a panoramic video view and to actively stop and zoom in on a particular image.
(b) There is no ability for the viewer to have varied viewing angles, including angles of elevation, so that a more comprehensive perspective is assured.
(c) What have been lacking are icons that can be included in the electronic display of panoramic imagery of a site that can be manipulated to include text, graphics and other items of interest regarding a site.

### SUMMARY

An embodiment of a system for capturing images of a specific site or conducting a site audit may include using a 360-degree panoramic camera or 360-degree panoramic video camera to capture images of the subject site. A camera compressor unit may be configured to compress and format the images captured for processing. The video or image capture is recorded and may be stored on a processor. The raw data may then be compressed with video capture software. The data may then be transferred from one computer to another by e-mail, storage device and the like. Once transferred, the data may be opened in editing software. In the editing software the data is compressed again and exported to a format readable by a viewer. The data can now be read by the viewer. Once in the viewer the user can manipulate the data to include text, graphics and other information by writing an .xml script. The processor or laptop computer for initially storing the images may be also used for displaying the images captured. An external hard drive may serve as a temporary storage component. A battery or DC power source may provide extended length of service for image capture and display.

An embodiment of a method of capture involves strategically utilizing a 360-degree panoramic camera or 360-degree panoramic video camera in such a way as to capture images whereby the subject site is circumscribed or surrounded with camera placement at various heights along a perimeter of the site. This method may also include capturing images at locations immersed within the subject site or at discrete locations within the subject site or facility. A display of the captured images may include icons imbedded within a panoramic image that would allow navigation between different images by way of a viewer clicking on the icons selected within the viewer. High-resolution images taken with a traditional directional camera and/or video camera or other graphics or data may be imbedded within the context of the 360-degree panoramic/spherical image and displayed when the viewer clicks on the icon.

### ADVANTAGES

Accordingly several advantages of one or more aspects are as follows: to provide site audit information by way of images of the subject site captured using a 360 degree panoramic camera or 360-degree panoramic video camera that can be viewed with multiple perspectives, the ability to be immersed within the site as well as being able to surround the subject site from various angles, elevations and distances, and the ability to incorporate within the panoramic image capture additional digital images and/or videos of “points of interest” (requiring high resolution or alternative lighting/viewing angles) within the site or location using traditional “directional” digital cameras and/or video systems. Other advantages of one or more aspects will be apparent from a consideration of the drawings and ensuing description.

### DRAWINGS

### Figures

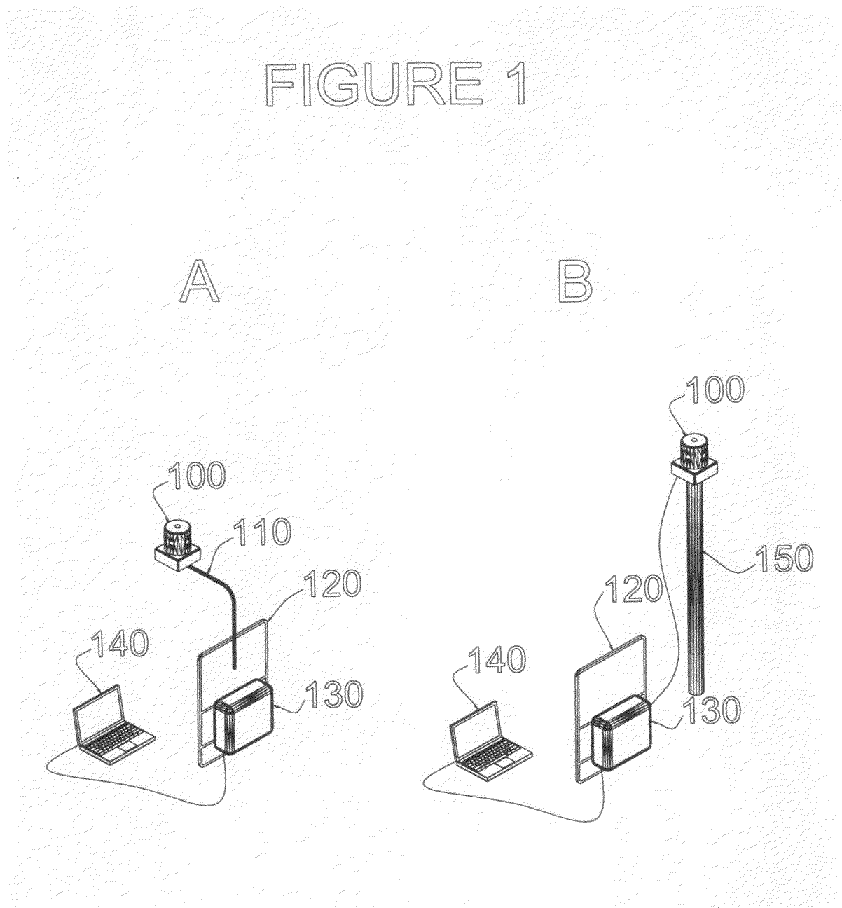

FIG. 1A shows a 360-degree panoramic video camera with connecting arm to a rigid backpack frame and portable power case containing a laptop computer or processor, compressor unit, a battery or DC power source.

FIG. 1B shows a 360-degree panoramic video camera attached to a variable height telescoping pole rather than fixed connecting arm with otherwise the same equipment configuration as in FIG. 1A.

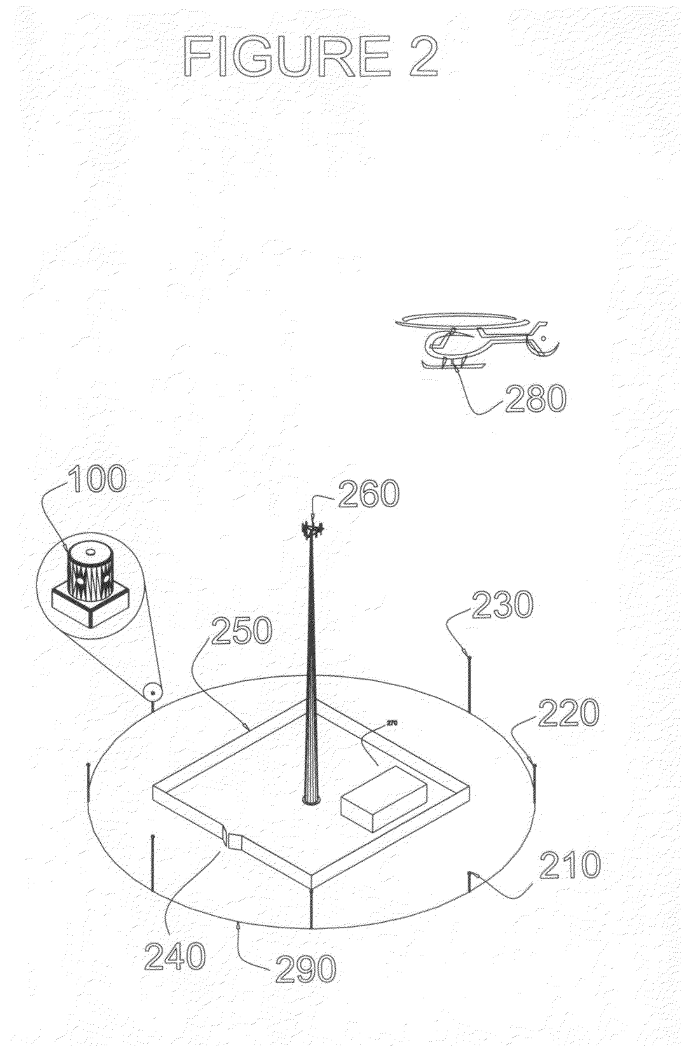

FIG. 2 shows the use of a strategically placed 360-degree camera around a perimeter circumscribing (or surrounding) a site or location with the camera placement at various heights to provide angles of image capture.

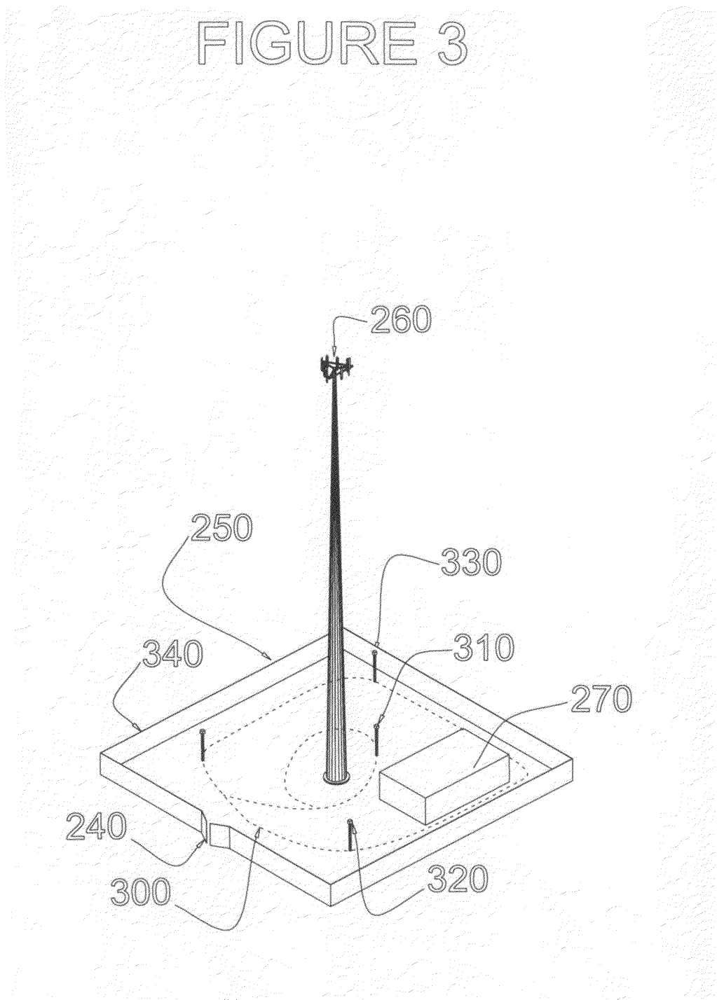

FIG. 3 shows a typical method for capturing immersed images/videos using a 360-degree panoramic or spherical video system.

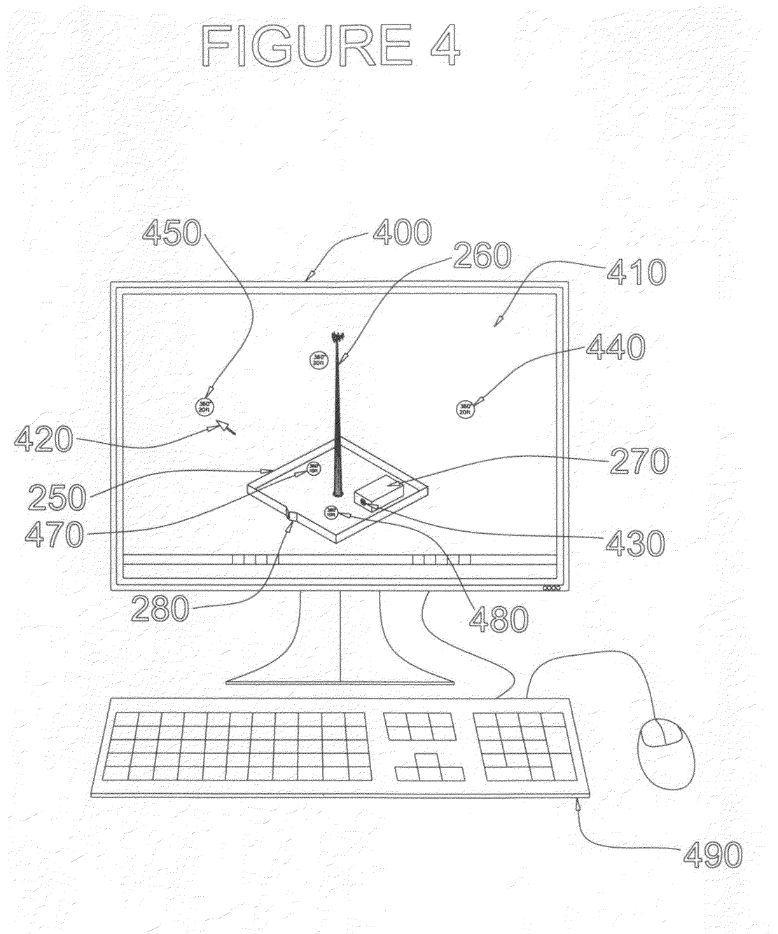

FIG. 4 shows a typical display of imbedded icons within a panoramic image that allows navigation between different images by clicking on the icons within the viewer.

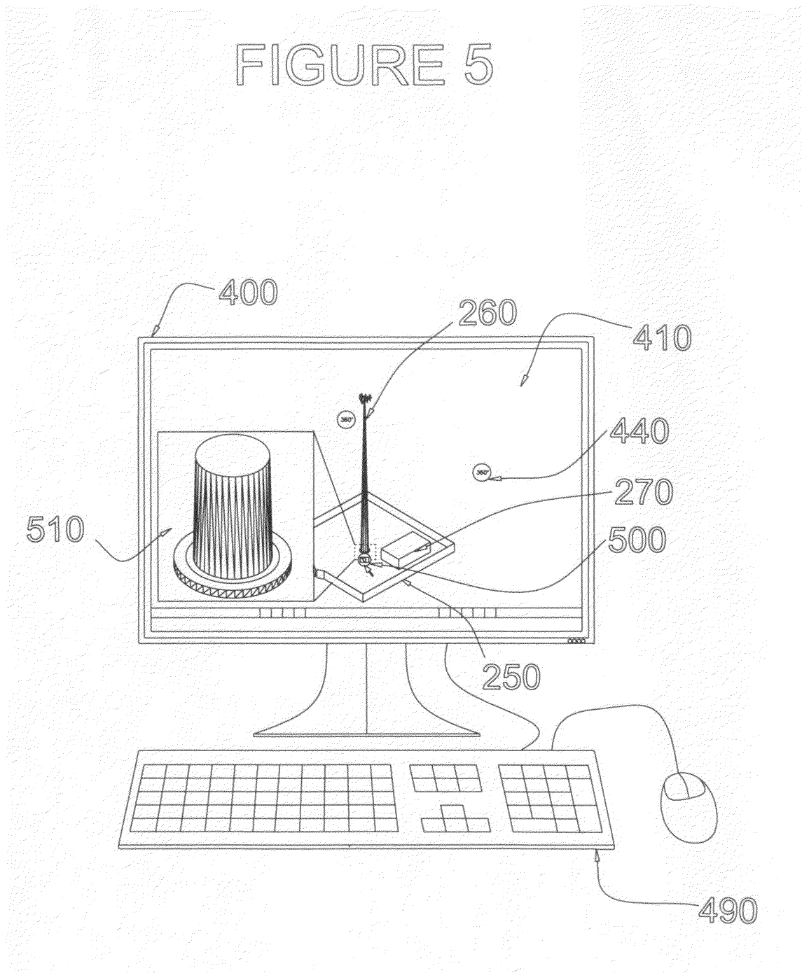

FIG. 5 shows a typical display of embedded high-resolution images taken with traditional directional camera and/or video system, which are displayed when the user clicks on the icon embedded within the context of the panoramic/spherical image.

### DRAWINGS

### Reference Numerals

100 typical 360-degree panoramic video camera
110 rigid connecting arm mount for 360-degree panoramic video camera
120 rigid back pack frame
130 power case with enclosed portable hard drive memory storage unit, laptop computer or processor when not used in viewfinder mode, compressor unit and battery
140 laptop computer outside power case when used by viewer as viewfinder for 360-degree panoramic video camera
150 typical telescoping pole that extends to variable heights up to 20′
210 360-degree panoramic video camera at 10′ height
220 360-degree panoramic video camera at 20′ height
230 360-degree panoramic video camera at 30′ height if using a typical, portable telescoping mast
240 access gate to site
250 typical fenced cell site
260 typical monopole cell tower
270 typical wireless radio equipment shelter
280 360-degree panoramic video camera aerial mount
290 perimeter of cell site
300 typical path for immersed image capture
310 360 camera at 7′ height near tower base
320 360 camera along path near shelter
330 360 camera along path on far side of tower
340 360 camera along path on near side of tower
400 typical computer desktop computer with monitor
410 viewing software program window
420 typical mouse pointer used to click on icons
430 detail icons, clicking will display an image/video with detail (see FIG. 5)
440 embedded navigational icon along perimeter towards far side/half of site
450 embedded navigational icon along perimeter towards near side/half of site
460 embedded navigational icon along perimeter with elevated tower view
470 embedded navigational icon within compound towards far side
480 embedded navigational icon within compound towards near side
490 typical computer keyboard with mouse
500 detail icon, clicking on same produces pop-up detail image/video
510 example of image/video (base of tower) displayed after clicking on embedded icon

### DETAILED DESCRIPTION

### First Embodiment—FIGS. 1A and 1B

One embodiment of the system is illustrated in FIG. 1A. The 360-degree panoramic video camera or spherical camera 100 can be any model or make with a plurality of lenses that performs the requisite image capture. The preferred such camera is available from Point Gray Research of Vancouver, Canada and is referred to as a “360-degree spherical, digital video capture system”. The camera 100 is connected by a light weight arm mount 110 to a rigid, backpack frame 120 with attached power case 130. The backpack frame and connecting arm can consist of any light weight material such as tubular aluminum or titanium. FIG. 1B shows that for greater camera height, the camera can be removed from the connecting arm and attached to the end of a typical telescoping pole for variable extension heights up to twenty feet 150.

In either connecting arm 110 or extension pole 150 mode, connecting wires run from the 360-degree panoramic video camera to the backpack power case 130 which houses a portable battery or DC power unit, an image compressor unit that is a component of the camera, a typical portable hard drive data storage unit, and a laptop computer or processor. In the event the camera operator wishes to use the laptop screen as a viewfinder, the laptop might be removed from the power case and supported on any typical lightweight sling style tray 140.

Video or image capture is recorded and stored on the laptop computer and the raw data is then compressed with video capture software. The data can then be transferred from one computer to another by email or storage device. Once transferred the data is opened in editing software. In the editing software the data is compressed again and exported to a format readable by the viewer. The data can now be read by the viewer. Once in the viewer, the user can manipulate the data to include text, graphics, directional video clips, and other manner of graphic information by writing an .xml script.

### Operation—FIGS. 2 and 3

The typical wireless cell site facility being audited includes a tower structure that supports antennas 260, connected by lines and conduits to radio equipment housed in either a shelter or in cabinets 270, within a compound surrounded by a fence 250 and accessed through a gated entrance 240.

One embodiment of the method for capturing images is illustrated in FIG. 2 whereby the typical 360-degree panoramic video camera 100 is located on the periphery 290 of the cell site facility being audited and progressing to multiple locations at various heights starting at ten feet 210, increasing to twenty feet 220, and then thirty feet 230, in sequence when using a single 360-degree panoramic video camera or simultaneously if using multiple cameras and with a secondary such camera mounted on a typical aircraft platform for five hundred feet or greater height image capture in those instances where such a perspective is desired 280. Obtaining the various elevations is achieved by mounting the 360-degree panoramic video camera on a connecting arm 110, telescoping extension pole 150, on an unmanned aerial vehicle, on a helicopter or other aircraft or any device capable of reaching various necessary altitudes relative to the subject site, location or object. Utilizing a series of anywhere from three to six or more camera vantage points “outside and above” the site, location or object in effect completely surrounds the subject. These images are captured in such a way as to allow any important viewing angle, including angles of elevation, to be captured so that any obstructions to what one wishes to view are minimized or eliminated.

The embodiment of the method for using the 360-degree panoramic video camera in the immersive mode rather than peripheral mode for image capture utilizes the 360-degree panoramic video camera with the connection arm mount 110 and provides a perspective of being at about eye level in order to capture the essence of one being within and throughout the site or location when moving through a path of travel 300. The embodiment also includes having multiple discrete immersed positions along the path of travel within the site compound but utilizing the telescoping pole 150 or portable telescoping mast instead of the fixed connection arm in order to gain extended viewing heights at various elevations for image capture 310,320, 330.

By combining images captured with both the peripheral as well as the immersive mode, images are captured inside, outside and above the site, location or object. Depending on the objective of the site audit, however, either mode may be used independently or in combination.

### Description

### Additional Embodiment—FIGS. 4 and 5

The method for combining and displaying 400, 410 of the 360-degree panoramic or spherical images involves the utilization of an interactive, PC based panoramic or spherical viewer software application (hereby referred to as the “viewer”) which is readily, commercially available.

The 360-degree panoramic camera video or image capture is recorded and may be stored on a processor. The raw data may then be compressed with typical video capture software. The data may then be transferred from one computer to another by e-mail, storage device and the like. Once transferred, the data may be opened in typical editing software. In the editing software the data is compressed again and exported to a format readable by a viewer. The data can now be read by the viewer. Once in the viewer the user can manipulate the data to include text, graphics and other information by writing an .xml script. The end user is able to navigate between the various 360-degree panoramic images and/or 360-degree videos that were captured 410. The method provides a color-coded and distinct set of embedded icons 430, 440, 450, 460, 470, 480 strategically placed within the various 360-degree panoramic images and/or 360-degree videos that allow the user to intuitively navigate 420, 490 between “surrounding, over-and-above” views and “immersed within” views of the cell site facility or location.

Additional digital images and/or videos of “points of interest” (requiring high resolution or alternative lighting/viewing angles) within the site are captured using traditional, directional digital cameras and/or video systems. There is no particular number of images or methodology for these images to be captured, other than using them to capture key points of interest that may not have been captured with enough clarity with the panoramic or spherical camera system(s). As described below, these specific images may be embedded within the 360-degree image capture.

An additional set of embedded icons within the viewer allow the user to select (within context) any point or object in order to view the higher resolution images of the subject 500. The higher resolution images/videos will display within the viewer or by method of “pop-up” windows 510. The viewer need only move the mouse so that the curser/pointer is on the icon and then click the mouse to either move a vantage point to the selected location or to have the higher resolution images display by way of “pop-up” windows.

### CONCLUSION, RAMIFICATIONS, AND SCOPE

Accordingly the reader will see that, while the above description contains many specificities, these should not be construed as limitations on the scope of the embodiment, but as exemplifications of various embodiments thereof. Many other ramifications and variations are possible within the teachings of the various embodiments. For example, the site method can be utilized for auditing, inspecting and assessing commercial and industrial facilities, roadways and construction projects and all manner of structures and site conditions, such as waterways and beach erosion. Icon display within the viewer or “pop-up” windows outside the viewer can display information and graphics beyond high resolution photographs or videos if desired. For instance, clicking on a selected icon can produce a display of a web site link, construction drawings of a site compound, a copy of the lease and deed for the subject site, structural drawings and analysis for the tower/antenna support structure, specifications of equipment found within the site and all manner of information and material germane to a site audit, inspection or assessment. The embodiment lends itself to site audits, inspections and assessments, which in turn can be used for site management and even site marketing purposes.

Thus the scope should be determined by the appended claims and their legal equivalents, and not by the examples given.

1. A system for capturing, combining and displaying 360-degree panoramic video or 360-degree spherical digital pictures, graphics or videos along with traditional directional digital images or videos of a specific site or object, said system comprising:
a. a 360-degree panoramic camera or 360-degree panoramic video camera with a plurality of lenses for site image capture,
b. an image compressor unit configured to compress images for processing by a processing unit,
c. a processing unit configured to load captured images and for displaying such images on an electronic display, and further configured with an interactive software program panoramic viewer enabling a user to navigate between or among various panoramic images or embedded images and information by selecting color-coded and distinct embedded icons,
d. editing software that may be used to open image data, compress it again and export it to a format readable by a viewer,
e. image data from a site that may be manipulated by the user once in the viewer to include text, graphics and other information by writing an .xml script and creating an associated icon,
f. an electronic display configured to display images and information associated with a site or object,
g. a pointer means which a user can manipulate to point to, select and click on an icon in order to display images and associated information,
h. a storage unit configured to store site images captured and graphic information added,
Whereby a user can view panoramic images of a site or object and also select a particular vantage point, image or information for display.

2. A method for capturing, combining and displaying 360-degree panoramic video or 360-degree spherical digital pictures, graphics or videos along with traditional directional digital images or videos of a specific site or object, said method comprising the steps;
a. capturing images and information associated with a site, location or object independently or in combination of two modes as follows:
1. comprising providing the 360-degree panoramic camera or 360-degree panoramic video camera and recording system using a telescoping pole is moved along a periphery of the subject site wherein images are captured at multiple locations along the periphery at heights of 10′, 20′ and greater,
2. comprising providing the 360-degree panoramic camera or 360-degree panoramic video camera and associated recording system is immersed within the site compound or close by the object and includes strategically placing the said camera at discrete locations within a path of travel,
b. obtaining additional photographic images of specific items or conditions at the site using a traditional digital camera or video recorder,
c. gathering data, graphics or other information associated with specific items or conditions at the site,
d. utilizing an interactive, processor based panoramic viewer software application that an operator may manipulate to combine and display panoramic images and wherein a color-coded, distinct set of icons may be embedded and strategically placed which enables the end user to intuitively navigate between and among various 360-degree images of the site captured at predetermined vantage points,
e. utilizing the viewer so that an operator may load and manipulate the 360-degree images captured at a site in combination with additional information and images of specific items and conditions of the site to be identified by creation of a corresponding icon, which thereafter may be selected by an end user viewing an electronic display of the site,
f. displaying electronic images and information of the subject site, location or object within the viewer or by way of pop-up windows in response to a user manipulating a pointer to select an icon or icons on the electronic display associated with a particular vantage point for viewing or to indicate information, text or a graphic representation of a particular item or condition of the subject site,
g. storing the information generated during the 360-degree image capture phase together with the combined information and images inserted by way of the viewer application and identified by associated icons,
Whereby a user can view panoramic images of a site or condition and select among specific icons for displaying of particular information or images associated with the subject.
